(19) United States
(12) Patent Application Publication
(10) Pub. No.: US 2022/0119648 A1
(43) Pub. Date: Apr. 21, 2022

(54) ADDITIVE WITH SYNERGY, SELF-REPAIRING AND ANTI-CORROSION, AND APPLICATION THEREOF

(71) Applicant: ZHEJIANG FENGHONG NEW MATERIAL CO., LTD., Huzhou (CN)

(72) Inventors: Chunwei WANG, Huzhou (CN); Xianglei LIAO, Huzhou (CN); Jinling LIU, Huzhou (CN); Jingjing LI, Huzhou (CN)

(21) Appl. No.: 17/272,372

(22) PCT Filed: Dec. 6, 2019
(86) PCT No.: PCT/CN2019/123645

§ 371 Date: Mar. 1, 2021

(30) Foreign Application Priority Data
Nov. 22, 2019 (CN) 201911154812.0

(51) Int. Cl. C09D 5/08; C09D 1/00

(52) U.S. Cl. CPC C09D 5/084; C09D 1/00

(57) ABSTRACT

The disclosure relates to the technical field of coating anti-corrosion, in particular to an additive with synergy, self-repairing, anti-corrosion and its application. The additive includes hydrotalcite containing exchangeable anions and zeolite containing exchangeable cations. Compared with the prior art, the present disclosure has both cation and anion exchange performance. When the corrosive electrolyte enters the coating film, it is in contact with the corrosion-resistant additive, and the corrosive ions (such as chloride ions or sodium ions) are adsorbed during the process of penetrating into the coating, and the corresponding anti-corrosion anions and cations are released, precipitated in the coating to close the gaps of the coating, or transferred to the metal substrate to form a protective layer, thereby acting as a barrier to protect the substrate and enhance the adhesion of the coating. Its anti-rust effect is obvious, and it can replace the anti-rust pigment containing lead or chromium.

### TECHNICAL FIELD

The present disclosure relates to the technical field of coating anti-corrosion, and in particular, to an additive with synergy, self-repairing, anti-corrosion and its application.

### BACKGROUND

Metal corrosion can cause economic losses, casualties, and environmental pollution, which is a major problem faced by countries all over the world. Paint coating on metal surface is the main measure to prevent metal corrosion and prolong life. The corrosion-inhibiting pigment developed by the British BP company is calcium-exchanged silica gel. Its preparation method is to transfer cationic calcium into the porous surface of spherical silica gel through ion exchange. Its principle of action includes two aspects, the absorption of aggressive ions and the formation of the protective film on the interface of the metal substrate. The first is that the corrosive ions such as sodium or hydrogen ions that penetrate into the coating film are exchanged with calcium ions on the surface of the silica gel particles to release calcium ions and then migrate to the interface of the metal substrate. On the other hand, the metal iron atoms in the anode area are oxidized to ferrous ions, and then further oxidized to iron ions, because air and moisture can penetrate the coating and penetrate to the interface between the coating and the metal substrate. Oxygen is reduced to hydroxide ions, according to the concentration of the hydroxyl ions in the coating, silicon dioxide can be more or less partially dissolved into silicate ions. The silicate ions react with iron ions at the interface to form a protective layer. At the same time, calcium ions on the surface of the silicon dioxide are released and react with the soluble silicate ions, so that a protective film of calcium silicate is formed in the basic area of the metal interface. Calcium silicate and iron silicate are deposited together to form a composite protective film layer on the metal interface, thereby strengthening the protective layer. The anti-corrosion mechanism is that: the corrosive ions from the surrounding environment, through the primer, preferentially exchange with the calcium ions on the surface of the pigment, and the released calcium moves to the interface, where a thin inorganic layer composed of calcium and silica is formed, with a thickness of about 25 Å. This protective layer is impermeable and can also isolate the corrosive environment from the metal surface, thereby stopping the corrosion process.

Compared with traditional anti-corrosion pigments, this kind of pigment has two major advantages: First, it releases corrosion inhibitor ions only when corrosive ions are present, so there is no need to use excessive pigments to compensate for the dissolution and consumption of pigments. Second, because the cross-linking reaction occurs according to the number of ions exchanged on the pigment surface, and the released corrosion inhibitor is insoluble in the paint, so the pores of the paint film will not increase, which can maintain a constant permeability. Therefore, the amount of calcium-exchanged silica pigment is less than that of traditional lead pigments and chromium pigments, and less than other low-toxicity pigments such as zinc phosphate.

The disadvantage of calcium-exchange silica gel ion-exchange pigments is that the chloride ion corrosion inhibition effect is not ideal. When chloride ions exist in the interface environment of the steel coating, under the action of the electric field generated by the corrosion battery, the chloride ions continue to migrate and concentrate in the anode area. Fe²⁺ and Cl⁻ generate water-soluble FeCl₂, and then diffuse outside the anode area, and form Fe(OH)₂ commonly known as “brown rust” with the OH⁻ in the bulk solution or the cathode area, and quickly transforms into other forms of rust when encountering the water and oxygen in the pore fluid. After FeCl₂ generates Fe(OH)₂, it releases Cl⁻ at the same time, and the new Cl⁻ migrates to the anode area, bringing out more Fe²⁺. Cl⁻ does not constitute a corrosion product, nor is it consumed during corrosion, and it repeatedly catalyzes corrosion. It can be seen that Cl⁻ plays an anodic depolarization effect on the corrosion of steel, accelerates the anodic reaction of steel, and promotes local corrosion of steel, which is the characteristic of chloride ion corrosion of steel. In coastal areas and heavy anti-corrosion areas, electrochemical corrosion of chloride ions is more harmful and a topic that needs to be solved urgently.

Buchheit et al. (Buchheit R G, Guan H, M ahajanam S, et al. Active corrosion protection and corrosion in chromate-free organic coating s [J]. Progress in Organic Coatings, 2003, 47(3/4):174-182.) prepared the vanadate intercalation hydrotalcite by the co-precipitation method, and the corrosion inhibition [V₁₀O₂₈]⁶⁻ was inserted between the layers. Due to the substitution of Al³⁺ for Zn²⁺ in the hydrotalcite framework, the main body of the zinc-aluminum layered compound is positively charged. The inserted [V₁₀O₂₈]⁶⁻ is located in the open channel of the hydrotalcite. As a nanocontainer, when the hydrotalcite comes into contact with the corrosive electrolyte containing Cl⁻, the negatively charged Cl⁻ will be quickly absorbed and at the same time the corrosion-inhibiting anion [V₁₀O₂₈]⁶⁻ will be released.

EP 0282619 A1 discloses a coating technology for controlling filiform corrosion of metal alloys. It uses organic acid salt modified hydrotalcite such as sodium stearate as a corrosion inhibitor. The addition of 2% of the corrosion inhibitor to the solvent-based acrylic baking paint significantly improves the capacity of resistance to filiform corrosion.

EP 11185839.5 discloses an anti-corrosion coating technology of synthetic layered double hydroxide (hydrotalcite) containing organic anions. The zinc-aluminum hydrotalcite containing m-aminobenzenesulfonate is synthesized by a direct precipitation method. The corrosion inhibitory effect of the zinc-aluminum hydrotalcite containing ethylenediaminetetraacetate is three times higher than that of the ethylenediaminetetraacetate containing zinc-aluminum hydrotalcite under the same addition amount in the coating, and more improved with respect to the corrosion inhibitory effect of the coating without hydrotalcite.

As a corrosion inhibitor, modified hydrotalcite has a certain effect on reducing or delaying the electrochemical corrosion of chloride ions. When modified hydrotalcite is used alone in salt spray or acid-base environment, the salts or acids formed by the anions exchanged by chloride ions, such as aluminate, molybdate, and phosphate have greater water solubility and cannot form a stable deposition protective film inside the coating and on the metal substrate.

In Chico B, Simancas J, Veg a J M, et al. Anti-corrosive behaviour of alkyd paints formulated with ion-exchange pigments [J]. Progress in Organic Coatings, 2008, 61(2/4):283-290. Anion exchange type vanadate intercalation Al—Zn hydrotalcite and calcium exchange silica gel ion exchange pigments are added to the alkyd resin coating. After natural exposure and damp heat, salt spray test, electrochemical impedance spectroscopy test, etc., the experimental research shows that the addition of two different ion-exchange corrosion inhibitors has a significant inhibitory effect on the corrosion of the carbon steel substrate under the coating film. Hydrotalcite with anion exchange performance can absorb Cl⁻ in aggressive media through ion exchange, so the coating shows better corrosion resistance in a chlorine-containing environment, while calcium exchange silica gel ion exchange pigments can undergo an ion exchange reaction via Ca²⁺ and 1-1⁺ in the environmental medium, so the coating has good protective performance in acidic or neutral environments. However, a comparative study found that for the low-carbon steel coating alkyd resin coating system, the anti-corrosion effect of the two ion-exchange fillers cannot reach the effect of traditional ZnCrO₄ pigments and fillers.

U.S. Pat. No. 7,481,877 B2 discloses a synergistic corrosion inhibitor containing at least two components, one of which is hydrotalcite or hydrotalcite-like, and the other is inorganic phosphate such as zinc phosphate, calcium phosphate, etc., or organic acid such as 2-(1,3-benzothiazole-2-thio) succinic acid, etc. Zinc phosphate and other inorganic phosphates in the coating slowly dissociate into phosphate ions, and the condensed phosphate ions react with the metal surface to form a complex adhesive Me-Zn—P₂O₅ compound covering film, which can passivate the metal, or form a complex between the metal surface and the paint. Zinc ions also form insoluble complexes, which play a role in cathodic protection and improve the initial anti-corrosion effect. But like other background techniques, it mainly forms a deposited protective film on the metal interface, mainly as a passive protection, and it is difficult to prevent the coating from swelling and gradually breaking.

### SUMMARY

The present disclosure is intended to provide an additive with synergy, self-repairing and anti-corrosion, which is composed of a layered hydrotalcite nanocontainer for specific exchange of anions and a zeolite nanocontainer in the shape of cubes and rhombuses for specific exchange of cations.

The technical solution of the present disclosure is as follows:

An additive with synergy, self-repairing and anti-corrosion includes hydrotalcite containing exchangeable anions and zeolite containing exchangeable cations.

As a preference of the above technical solution, the mass parts of the hydrotalcite is 10 to 80, and the mass parts of the zeolite is 20 to 90.

Preferably, the hydrotalcite contains one or more of the following exchangeable anions between layers: carbonate, molybdate, vanadate, pyrovanadate, metavanadate, phosphate, phosphite, pyrophosphate, metaphosphate, tripolyphosphate, metaborate, chromate and dichromate.

Preferably, the zeolite contain one or more of the following exchangeable cations in its pores: trivalent aluminum ion, divalent zinc ion, divalent calcium ion, divalent barium ion, divalent manganese ion, trivalent iron ion, valence chromium ion, divalent strontium ion and rare earth element ion.

Preferably, the mass parts of the hydrotalcite is 30 to 60, and the mass parts of the zeolite is 40 to 70.

Preferably, the hydrotalcite is a modified hydrotalcite containing exchangeable anions prepared by an ion exchange method.

Preferably, the zeolite is a modified zeolite containing exchangeable cations prepared by an ion exchange method.

Another object of the present disclosure is to provide application of the aforementioned additive with synergy, self-repairing and anti-corrosion in the preparation of anti-corrosion coatings.

Preferably, the anti-corrosion is salt water resistance, salt spray resistance, and acid and alkali corrosion resistance.

Preferably, the anti-corrosion mechanism is to absorb and exchange corrosive substances in the environment to form water-insoluble deposits, and the deposits can automatically fill and repair the gaps in the coating to prevent further penetration of corrosive substances.

Compared with the prior art, the present disclosure has both cation and anion exchange performance. When the corrosive electrolyte enters the coating film, it is in contact with the corrosion-resistant additive, and corrosive ions (such as chloride ions or sodium ions) is adsorbed during the process of penetrating into the coating. The corresponding anti-corrosion anions and cations are released and precipitates in the coating to close the gap of the coating, or transfers to the metal substrate to form a protective layer, which acts as a barrier and protects the substrate. The adhesion of the coating is enhanced, its anti-rust effect is obvious, and can replace anti-rust pigments containing lead or chromium.

Compared with the prior art, the biggest advantage of the present disclosure is that the coating has a self-repairing and anti-corrosive function. When the coating is corroded by corrosive substances such as sodium chloride and acid-alkali, it absorbs water-soluble corrosive anions and cations while forming water insoluble anti-corrosive pigment in situ. The coating gaps can be automatically repaired, the further penetration of corrosive substances is isolated into the metal substrate, and the life of the coating film can be extended. Exchangeable anions and cations have wider selectivity. In addition to commonly used carbonate and aluminate, the anions can be modified hydrotalcite such as molybdate, phosphate, metaboric acid and chromic acid. The cations can be, in addition to commonly used calcium, zinc, and iron, prepared as modified zeolites such as strontium, cerium, lanthanum, manganese, barium, etc., to meet the needs of different metal anti-corrosive coatings. For example, in bisphenol A epoxy primer, cerium modified mordenite and sodium phosphate modified hydrotalcite are synergistic the anti-corrosion effect of aluminum alloy, which is better than the classic but toxic strontium chromate.

Hydrotalcite (LDHs) layered compound is a kind of anionic layered clay that has developed rapidly in recent years. It is a compound formed by the accumulation of interlayer anions and positively charged layers. The ratio of layered metal elements can be adjustable, with the characteristics of the exchange of anions. The general chemical formula is [M²⁺₁₋ₓM³⁺ₓ(OH)₂]^{x+}(Aⁿ⁻)_{x/n}.mH₂O, where M²⁺ and M³⁺ respectively represent the divalent and trivalent metal ions occupying the center of the octahedral hydroxide on the laminate. The M²⁺ and M³⁺ that can be allowed to enter the hydrotalcite layer may have an ion radius similar to that of Mg²⁺.

Common divalent metal ions are: Mg²⁺, Zn²⁺, Ni²⁺, Cu²⁺, Co²⁺, Mn²⁺, Fe²⁺; trivalent metal ions are: Al²⁺, Fe²⁺, Cr²⁺. The effective combination of these divalent and trivalent ions can form two, three or even quaternary hydrotalcites. The closer the radii of M²⁺ and M³⁺ are, the easier it is to form a stable laminate.

Aⁿ⁻ is an interlayer anion, including F⁻, Cl⁻, Br⁻, I⁻, ClO4⁻, NO₃⁻, ClO₃⁻, IO₃⁻, OH⁻, H₂PO₄⁻, CO₃²⁻, SO₃²⁻, SO₄²⁻, CrO₄²⁻, PO₄³⁻, Fe(CN)₆³⁻, Fe(CN)₆⁴⁻, Zn(BPS)₃⁴⁻, Ru(BPS)₃³⁻, Mo₇O₂₄⁶⁻, V₁₀O₂₈⁶⁻, PW₁₁CuO₃₉⁶⁻ etc. Generally, the number, volume, valence state of the anions and the bonding strength between the anions and the hydroxyl groups of the laminate determine the interlayer spacing and interlayer space of the anionic layered compound.

x is the structural parameter of LDHs, x=M³⁺/[M²⁺+M³⁺]. Therefore, the value of x directly affects the composition of the product. Generally, to synthesize pure LDHs, it must meet 0.17≤x≤0.34. The change of x value may lead to the formation of compounds with different structures.

m is the number of crystal water. As the ratio x increases, the number of crystal water gradually decreases.

n is the number of interlayer anion charges.

Natural hydrotalcite with economic value is scarce in nature. The production method of hydrotalcite adopted in the present disclosure may include co-precipitation, hydrothermal, ion exchange, roasting reduction, and nucleation-crystallization isolation method.

Zeolite is a kind of minerals that exists widely in nature, with a variety of structure, such as analcime, clinoptilolite, corroded zeolite, erionite, heulandite, etc., so far more than 40 kinds of natural zeolite structures have been discovered. However, the structure of natural zeolite identified and named by the International Zeolite Society is less than 30. The first synthetic method used for synthetic zeolite (molecular sieve) is to imitate the geological formation conditions of natural zeolite and adopt high-temperature hydrothermal synthesis technology to synthesize, mainly including type A, X-type, L-type, Y-type zeolite, mordenite, ZSM, MCM and aluminum phosphate molecular sieve. Zeolite (molecular sieve) has a porous cage structure, the pore type is more complicated, the pore size is 0.3 nm˜2 nm. The specially designed zeolite (molecular sieve) can reach more than 20 nm, and the cation exchange capacity (CEC) of zeolite (molecular sieve) is mostly 50˜300 mmol/100 g. Zeolite (molecular sieve) with suitable pore size and ion exchange capacity meets the requirements of this technology as a nanocontainer. Most of the interlayer cations of zeolite (molecular sieve) are sodium ions, which are prepared as zeolite with different interlayer cations by ion exchange methods.

The following lists the zeolite (molecular sieve) that meets the requirements of the present disclosure as a nanocontainer:

| Zeolite | | Pore | Dimen- | Pore |
|---|---|---|---|---|
| (Molecular Sieve) | Code | System | sion | Size/nm |
| Linde A | LTA | 8-8-8- | 3 | 0.41 |
| Chabazite | CHA | 8-8-8 | 3 | 0.38*0.38 |
| Erionite | ERI | 8-8 | 3 | 0.36*0.51 |
| ZSM-23 | MTT | 10 | 1 | 0.45*0.52 |
| ZSM-48 | | 10 | 1 | 0.53*0.56 |
| Ferrierite | FER | 10-8 | 2 | 0.43*0.55 |
| ZSM-5 | MFI | 10-10 | 3 | 0.53*0.56 |
| ZSM-11 | MEL | 10-10 | 3 | 0.58*0.54 |
| ZSM-12 | MTW | 12 | 1 | 0.55*0.59 |
| Linde L | LTL | 12 | 1 | 0.71 |
| Mordenite | MOR | 12-8 | 2 | 0.65*0.70 |
| Chabazite | OFF | 12-8-8 | 3 | 0.67 |
| Faujasite | FAU | 12-12-12 | 3 | 0.74 |
| AIP0₄-8 | AET | 14 | 1 | 0.79*0.87 |
| VPI-5 | VFI | 18 | 1 | 1.21 |
| Cloverite | CLO | 20-20-20 | 3 | 1.32*0.40 |
| JDF-20 | | 20-10-8 | 3 | 1.45*0.62 |

In summary, the present disclosure has the following beneficial effects:

The present disclosure has both cation and anion exchange performance. When the corrosive electrolyte enters the coating film, it is in contact with the corrosion-resistant additive, and the corrosive ions (such as chloride ions or sodium ions) are adsorbed during the process of penetrating into the coating, and the corresponding anti-corrosion anions and cations are released, precipitated in the coating to close the gaps of the coating, or transferred to the metal substrate to form a protective layer, thereby acting as a barrier to protect the substrate and enhance the adhesion of the coating. Its anti-rust effect is obvious, and it can replace the anti-rust pigment containing lead or chromium. Compared with the prior art, the biggest advantage of the present disclosure is that the coating has a self-repairing and anti-corrosive function. When the coating is corroded by corrosive substances such as sodium chloride and acid-alkali, it absorbs water-soluble corrosive anions and cations while forming water insoluble anti-corrosive pigment in situ. The coating gaps can be automatically repaired, the further penetration of corrosive substances is isolated into the metal substrate, and the life of the coating film can be extended.

In addition, the additive with synergy, self-healing and anti-corrosion according to the present disclosure is added to the paint after specific anionic modified hydrotalcite and specific cationic modified zeolite mixed in proportions. Alternatively, the former two can also be added to the paint separately. The production and manufacturing process of the paint are the same as usual.

### BRIEF DESCRIPTION OF THE DRAWINGS

FIG. 1 is the test result of the first example according to the present disclosure.

### DETAILED DESCRIPTION OF EMBODIMENTS

The present disclosure will be further described below in combination with the accompanying drawings.

The specific embodiment is only an explanation of the present disclosure, and is not a limitation to the present disclosure. Any changes made by those skilled in the art after reading the specification of the present disclosure will be protected by the patent law as long as they fall within the scope of the claims.

### Example 1

An additive with synergy, self-repairing and anti-corrosion, may be composed of 5A zeolite and phosphoric acid modified hydrotalcite. The details are as follows:

1, 100 g of hydrotalcite may be added to 2000 g of water, and then stirred and dispersed at 75° C. for 1 hour; 75.26 g of trisodium phosphate that is 1.8 times the ion exchange capacity of the hydrotalcite may be added and continue the reaction for 1 hour. After the reaction is over, the powder may be centrifuged and dried;

2, the 5A zeolite and the modified hydrotalcite may be physically blended at a molar ratio of 1:1 after exchange, to obtain an anti-corrosion additive.

### Example 2

An additive with synergy, self-repairing and anti-corrosion, may be composed of zinc-modified clinoptilolite and molybdic acid-modified hydrotalcite. The details are as follows:

1, 100 g of clinoptilolite powder may be added to 2000 g of water, and then stirred and dispersed at 75° C. for 1 hour; 30.96 g of zinc sulfate that is 1.8 times the ion exchange capacity of clinoptilolite may be added and continue the reaction for 1 hour. After the reaction is over, the powder may be centrifuged and dried;

2, 100 g of hydrotalcite may be added to 2000 g of water, and then stirred and dispersed at 75° C. for 1 hour; 61.17 g of sodium molybdate that is 1.8 times the ion exchange capacity of the hydrotalcite may be added and continue the reaction for 1 hour. After the reaction is over, the powder may be centrifuged and dried;

3, the modified clinoptilolite and hydrotalcite may be physically blended at a molar ratio of 1:1 after exchange, to obtain an anti-corrosion additive.

### Example 3

An additive with synergy, self-repairing and anti-corrosion, may be composed of bismuth modified mordenite and vanadic acid modified hydrotalcite. The details are as follows:

1, 100 g of mordenite powder may be added to 2000 g of water, and then stirred and dispersed at 75° C. for 1 hour; 52.9 g of bismuth nitrate that is 1.8 times the ion exchange capacity of clinoptilolite may be added and continue the reaction for 1 hour. After the reaction is over, the powder may be centrifuged and dried;

2, 100 g of hydrotalcite may be added to 2000 g of water, and then stirred and dispersed at 75° C. for 1 hour; 36.4 g of sodium vanadate that is 1.8 times the ion exchange capacity of the hydrotalcite may be added and continue the reaction for 1 hour. After the reaction is over, the powder may be centrifuged and dried;

3, the modified mordenite and the hydrotalcite may be physically blended at a molar ratio of 1:1 after exchange, to obtain an anti-corrosion additive.

### Example 4

An additive with synergy, self-repairing and anti-corrosion, may be composed of aluminum modified clinoptilolite and phosphorous acid modified hydrotalcite. The details are as follows:

1, 100 g of clinoptilolite powder may be added to 2000 g of water, and then stirred and dispersed at 75° C. for 1 hour; 43.7 g of aluminum sulfate that is 1.8 times the ion exchange capacity of clinoptilolite may be added and continue the reaction for 1 hour. After the reaction is over, the powder may be centrifuged and dried;

2, 100 g of hydrotalcite may be added to 2000 g of water, and then stirred and dispersed at 75° C. for 1 hour; 64.2 g of sodium phosphite that is 1.8 times the ion exchange capacity of the hydrotalcite may be added and continue the reaction for 1 hour. After the reaction is over, the powder may be centrifuged and dried;

3, the modified clinoptilolite and hydrotalcite may be physically blended at a molar ratio of 1:1 after exchange, to obtain an anti-corrosion additive.

### Example 5

An additive with synergy, self-repairing and anti-corrosion, may be composed of cerium modified mordenite and citric acid modified hydrotalcite. The details are as follows:

1, 100 g of mordenite powder may be added to 2000 g of water, and then stirred and dispersed at 75° C. for 1 hour; 58.1 g of cerium nitrate that is 1.8 times the ion exchange capacity of clinoptilolite may be added and continue the reaction for 1 hour. After the reaction is over, the powder may be centrifuged and dried;

2, 100 g of hydrotalcite may be added to 2000 g of water, and then stirred and dispersed at 75° C. for 1 hour; 38.8 g of sodium citrate that is 1.8 times the ion exchange capacity of the hydrotalcite may be added and continue the reaction for 1 hour. After the reaction is over, the powder may be centrifuged and dried;

3, the modified mordenite and the hydrotalcite may be physically blended at a molar ratio of 1:1 after exchange, to obtain an anti-corrosion additive.

### Example 6

An additive with synergy, self-repairing and anti-corrosion, may be composed of aluminum modified clinoptilolite and tripolyphosphoric acid modified hydrotalcite. The details are as follows:

1, 100 g of clinoptilolite powder may be added to 2000 g of water, and then stirred and dispersed at 75° C. for 1 hour; 43.7 g of aluminum sulfate that is 1.8 times the ion exchange capacity of clinoptilolite may be added and continue the reaction for 1 hour. After the reaction is over, the powder may be centrifuged and dried;

2, 100 g of hydrotalcite may be added to 2000 g of water, and then stirred and dispersed at 75° C. for 1 hour; 43.7 g of sodium tripolyphosphate that is 1.8 times the ion exchange capacity of the hydrotalcite may be added and continue the reaction for 1 hour. After the reaction is over, the powder may be centrifuged and dried;

3, the modified clinoptilolite and hydrotalcite may be physically blended at a molar ratio of 1:1 after exchange, to obtain an anti-corrosion additive.

### Example 7

An additive with synergy, self-repairing and anti-corrosion, may be composed of zinc modified clinoptilolite and phosphoric acid modified hydrotalcite. The details are as follows:

1, 100 g of clinoptilolite powder may be added to 2000 g of water, and then stirred and dispersed at 75° C. for 1 hour; 31.0 g zinc sulfate that is 1.8 times the ion exchange capacity of clinoptilolite may be added and continue the reaction for 1 hour. After the reaction is over, the powder may be centrifuged and dried;

2, 100 g of hydrotalcite may be added to 2000 g of water, and then stirred and dispersed at 75° C. for 1 hour; 75.26 g of trisodium phosphate that is 1.8 times the ion exchange capacity of the hydrotalcite may be added and continue the reaction for 1 hour. After the reaction is over, the powder may be centrifuged and dried;

3, the modified clinoptilolite and hydrotalcite may be physically blended at a molar ratio of 1:1 after exchange, to obtain an anti-corrosion additive.

### Example 8

An additive with synergy, self-repairing and anti-corrosion, may be composed of lanthanum modified X-type zeolite and citric acid modified hydrotalcite. The details are as follows:

1, 100 g of clinoptilolite powder may be added to 2000 g of water, and then stirred and dispersed at 75° C. for 1 hour; 110 g lanthanum nitrate that is 1.8 times the ion exchange capacity of clinoptilolite may be added and continue the reaction for 1 hour. After the reaction is over, the powder may be centrifuged and dried;

2, 100 g of hydrotalcite may be added to 2000 g of water, and then stirred and dispersed at 75° C. for 1 hour; 58.2 g of sodium citrate that is 1.8 times the ion exchange capacity of the hydrotalcite may be added and continue the reaction for 1 hour. After the reaction is over, the powder may be centrifuged and dried;

3, the modified X-type zeolite and the hydrotalcite may be physically blended at a molar ratio of 1:1 after exchange, to obtain an anti-corrosion additive.

### Example 9

An additive with synergy, self-repairing and anti-corrosion, may be composed of hydrophobically modified 5A zeolite and phosphoric acid modified hydrotalcite. The details are as follows:

1, 100 g of 5A zeolite powder may be added to 2000 g of water, and then stirred and dispersed at 75° C. for 1 hour; 3% octyltriethoxysilane powder may be added for hydrophobic modification and continue the reaction for 1 hour. After the reaction is over, the powder may be centrifuged and dried;

2, 100 g of hydrotalcite may be added to 2000 g of water, and then stirred and dispersed at 75° C. for 1 hour; 75.26 g of trisodium phosphate that is 1.8 times the ion exchange capacity of the hydrotalcite may be added and continue the reaction for 1 hour. After the reaction is over, the powder may be centrifuged and dried;

3, the modified 5A zeolite and the hydrotalcite may be physically blended at a molar ratio of 1:1 after exchange, to obtain an anti-corrosion additive.

The additive with synergy, self-repairing and anti-corrosion can be used in combination with anti-corrosion pigments and coloring pigments. It may be added before the high-speed dispersion and grinding stage of the coating. The addition amount may be 1%˜10% of the total coating formula. The commonly used addition amount may be 2%˜6%. The corrosion resistance evaluation method adopts ISO 4628, and the rust is divided into six levels, namely Ri0: rust area=0; Ri1: rust area≤0.05%; Ri2: rust area≤50.5%; Ri3: rust area≤1%, Ri4: rust area≤8%, Ri5: rust area is 40-50%. There are six levels of foaming, namely 0: no foaming; 1: fewer foaming; 2: more visible foaming with a particle size of less than 0.5 mm; 3: more foaming with a smaller particle size 0.5-5 mm; 4: foaming particle size greater than 5 mm; 5: severe foaming.

### Application Example 1: The Additive with Synergy, Self-Repairing and Anti-Corrosion Applied to Water-Based Alkyd Resin Coatings

| Raw Material | \textcircled{1} | \textcircled{2} | \textcircled{3} |
|---|---|---|---|
| Water | 14.8 | 14.8 | 14.8 |
| K9N Fungicide | 0.2 | 0.2 | 0.2 |
| HYDROPALAT 34 Dispersant | 1.0 | 1.0 | 1.0 |
| HYDROPALAT 3037 Wetting | 0.2 | 0.2 | 0.2 |
| Agent | | | |
| FOMASTER-NXZ Defoamer | 0.5 | 0.5 | 0.5 |
| bayferrox 225 Iron Oxide Red | 10 | 10 | 10 |
| 800 mesh Talcum Powder | 12 | 12 | 12 |
| 800 mesh Barium Sulfate | 8 | 10 | 8 |
| Anti-corrosion Additive | 2.0 | Not | 2.0 |
| | (Exam- | added | (Shieldex |
| | ple1) | | AC5) |
| BP-188 Bentonite | 0.4 | 0.4 | 0.4 |
| Alcophor 827 Organic Corrosion | 1.0 | 1.0 | 1.0 |
| Inhibitor | | | |
| Uradil AZ3530 Alkyd Resin | 43 | 43 | 43 |
| ADDITOL VXW4940N Drier | 0.7 | 0.7 | 0.7 |
| Halox Flash-X 150 Anti-flash Rust | 1.0 | 1.0 | 1.0 |
| Agent | | | |
| EFKA3035 Leveling Agent | 0.3 | 0.3 | 0.3 |
| ACRYSOLTM RM-8W Thickener | 0.4 | 0.4 | 0.4 |
| Water | 4.5 | 4.5 | 4.5 |
| | 100 | 100 | 100 |
| Rust Level | Ri0 | Ri2 | Ril |
| Foaming level | 0 | 2 | 1 |

Specific operation: the 8 kinds of raw material, such as water, dispersant, defoamer, wetting agent, iron red, barium sulfate, talc, corrosion inhibitor and bentonite, may be pre-dispersed uniformly, and then alkyd resin, drier, leveling agent, anti-flash rust agent and thickener may be added to it, and dispersed again, they may be adjusted to the proper viscosity with water.

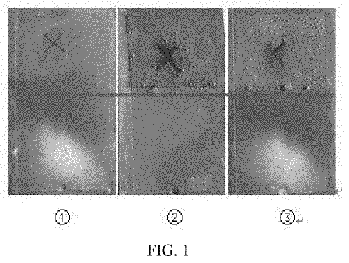

The board may be painted and sprayed according to the test formula given above, and placed at room temperature for 7 days, baked at 80° C. for 1 hour, and then put in a salt spray box for 500 hours. The test results are shown in FIG. 1. FIG. 1 is the anti-corrosion effect of the additive with synergy, self-repairing and anti-corrosion in the water-based alkyd paint (\textcircled{1} represents adding the anti-corrosion additive of the present disclosure; \textcircled{2} represents not adding the anti-corrosion additive; \textcircled{3} represents competitive anti-corrosion additive). The competitive anti-corrosion additive uses calcium ion exchange silica gel Shieldex AC5. The results show that the treatment of the present disclosure significantly improves the anti-corrosive effect of the water-based alkyd paint.

### Application Example 2: The Additive with Synergy, Self-Repairing and Anti-Corrosion Applied in Waterborne Epoxy Primers

| Raw Material | \textcircled{1} | \textcircled{2} | \textcircled{3} | \textcircled{4} |
|---|---|---|---|---|
| Water | 12.6 | 12.6 | 12.6 | 12.6 |
| K9N Fungicide | 0.2 | 0.2 | 0.2 | 0.2 |
| HYDROPALAT 34 | 1.0 | 1.0 | 1.0 | 1.0 |
| Dispersant | | | | |
| HYDROPALAT 3037 | 0.2 | 0.2 | 0.2 | 0.2 |
| Wetting Agent | | | | |
| FOMASTER-NXZ | 0.5 | 0.5 | 0.5 | 0.5 |
| Defoanner | | | | |
| Lanninox F Mica Iron | 14 | 14 | 14 | 14 |
| Oxide | | | | |
| 800 mesh Talcum | 9 | 9 | 9 | 9 |
| Powder | | | | |
| Anti-Corrosion | 10 | 10 | 10 | 10 |
| Additive | (Exam- | (Exam- | (HALOX391 | (L203E |
| | ple2) | ple3) | zinc | strontium |
| | | | phosphate) | chromate) |
| SMP-HV3 Bentonite | 0.4 | 0.4 | 0.4 | 0.4 |
| EPIKOTET ™ | 50 | 50 | 50 | 50 |
| 6520-WH-53A | | | | |
| Epoxy Resin | | | | |
| Halox Flash-X 150 | 1.0 | 1.0 | 1.0 | 1.0 |
| Anti-flash Rust Agent | | | | |
| EFKA3035 leveling | 0.3 | 0.3 | 0.3 | 0.3 |
| agent | | | | |
| ACRYSOLTM | 0.8 | 0.8 | 0.8 | 0.8 |
| RM-8W | | | | |
| Thickener | | | | |
| | 100 | 100 | 100 | 100 |
| EPIKURE 6870- | 20 | 20 | 20 | 20 |
| W-53 | | | | |
| Curing Agent | | | | |
| Rust Level | Ri0 | Ri0 | Ri2 | Ri0 |
| Foaming Level | 0 | 1 | 1 | 0 |

Specific operation: water, dispersant, defoamer, wetting agent, titanium dioxide, barium sulfate, talcum powder, and corrosion inhibitor, may be pre-dispersed uniformly, and then epoxy resin may be added to it, and dispersed again; anti-flash rust agent and leveling agent may be added, and uniformly dispersed and prepared.

The board may be painted and sprayed according to the test formula given above, with 20% modified alicyclic amine epoxy curing agent added, and placed at room temperature for 7 days, baked at 80° C. for 1 hour, and then put in a salt spray box for 800 hours. The test results show that the treatment of the present disclosure significantly improves the anti-corrosive effect of the water-based epoxy paint.

### Application Example 3: The Additive with Synergy, Self-Repairing and Anti-Corrosion Applied in Solvent-Based Epoxy Primers

Specifically, the anti-corrosion epoxy primer may be formulated according to the following formula.

| Raw Material | \textcircled{1} | \textcircled{2} | \textcircled{3} | \textcircled{4} |
|---|---|---|---|---|
| E-51 Epoxy Resin | 40 | 40 | 40 | 40 |
| EFKA5220 Dispersant | 0.5 | 0.5 | 0.5 | 0.5 |
| EFKA2020 Defoanner | 0.5 | 0.5 | 0.5 | 0.5 |
| R-902 Rutile Titanium | 13.5 | 13.5 | 13.5 | 13.5 |
| Dioxide | | | | |
| 800 mesh Barium Sulfate | 12 | 12 | 12 | 12 |
| 800 mesh Talcum | 10 | 10 | 10 | 10 |
| Powder | | | | |
| BP-127 Organic | 0.5 | 0.5 | 0.5 | 0.5 |
| Bentonite | | | | |
| Anti-corrosion Additive | 8.5 | 8.5 | 8.5 | 8.5 |
| | (Exam- | (Exam- | (K-white | (243-XF |
| | ple 4) | ple 5) | 80 | zinc |
| | | | aluminum | chromate) |
| | | | phosphate) | |
| Halox 650 Organic | 1.5 | 1.5 | 1.5 | 1.5 |
| Anti-corrosion Agent | | | | |
| Xylene | 6.4 | 6.4 | 6.4 | 6.4 |
| N-butanol | 6.4 | 6.4 | 6.4 | 6.4 |
| EFKA3772 Leveling | 0.2 | 0.2 | 0.2 | 0.2 |
| Agent | | | | |
| | 100 | 100 | 100 | 100 |
| NX-2018 Phenalkannine | 30 | 30 | 30 | 30 |
| Curing Agent | | | | |
| Rust Level | Ri0 | Ri0 | Ri2 | Ri0 |
| Foaming Level | 0 | 0 | 1 | 0 |

Specific operation: the materials in the above formula may be mixed and dispersed uniformly to prepare the additive.

The board may be painted and sprayed according to the test formula given above, placed at room temperature for 7 days, and then put in the salt spray box for 1000 hours. The results show that the treatment of the present disclosure makes the anti-corrosion effect of the epoxy primer significantly improved.

### Application Example 4: The Additive with Synergy, Self-Repairing and Anti-Corrosion Applied in Water-Based Acrylic Coatings

Specifically, the anti-corrosive waterborne acrylic paint may be formulated according to the following formula.

| Raw Material | \textcircled{1} | \textcircled{2} | \textcircled{3} | \textcircled{4} |
|---|---|---|---|---|
| Water | 13 | 13 | 13 | 13 |
| K9N Fungicide | 0.2 | 0.2 | 0.2 | 0.2 |
| HYDROPALAT 34 | 1.0 | 1.0 | 1.0 | 1.0 |
| Dispersant | | | | |
| FOMASTER-NXZ | 0.5 | 0.5 | 0.5 | 0.5 |
| Defoanner | | | | |
| HYDROPALAT 3037 | 0.2 | 0.2 | 0.2 | 0.2 |
| Wetting Agent | | | | |
| BP-188B Bentonite | 0.3 | 0.3 | 0.3 | 0.3 |
| Propylene Glycol | 3.3 | 3.3 | 3.3 | 3.3 |
| Texanol | 0.7 | 0.7 | 0.7 | 0.7 |
| bayferrox 225 Iron | 10 | 10 | 10 | 10 |
| Oxide Red | | | | |
| 800 mesh Mica | 4.3 | 4.3 | 4.3 | 4.3 |
| 800 mesh Talcum | 10 | 10 | 10 | 10 |
| Powder | | | | |
| Anti-Corrosion | 5 | 5 | 5 | 5 |
| | (Exam- | (Exam- | (HALOX391 | (L203 |
| Additive | ple 6) | ple 7) | Zinc | Strontium |
| | | | Phosphate) | Chromate) |
| NeoCryl XK86 | 50 | 50 | 50 | 50 |
| Acrylic | | | | |
| Resin | | | | |
| Halox Flash-X 150 | 1.0 | 1.0 | 1.0 | 1.0 |
| Anti-flash Rust Agent | | | | |
| EFKA3035 Leveling | 0.3 | 0.3 | 0.3 | 0.3 |
| Agent | | | | |
| ACRYSOLTM | 0.2 | 0.2 | 0.2 | 0.2 |
| RM-8W | | | | |
| Thickener | | | | |
| | 100 | 100 | 100 | 100 |
| Rust Level | Ri0 | Ri0 | Ri3 | Ri1 |
| Foaming Level | 1 | 0 | 2 | 1 |

Specific operation: water, bactericide, dispersant, defoamer, wetting agent, bentonite, propylene glycol, film-forming aid, iron red, mica, talcum powder, corrosion resistant agent are pre-dispersed uniformly, and then acrylic resin, leveling agent are added with anti-flash rust agent, dispersed uniformly again; thickener is adopted to adjust viscosity.

The board may be painted and sprayed according to the test formula given above, placed at room temperature for 7 days, baked at 80° C. for 1 h; and then put in a salt spray box for 300 h. The results show that the treatment of the present disclosure makes the anti-corrosion effect of the water-based acrylic paint significantly improved.

### Application Example 5: The Additive with Synergy, Self-Repairing and Anti-Corrosion Applied in Chlorinated Rubber Paint

Specifically, the anti-corrosion chlorinated rubber paint may be formulated according to the following formula.

| Raw Material | \textcircled{1} | \textcircled{2} | \textcircled{3} |
|---|---|---|---|
| CR-20 Chlorinated | 23.6 | 23.6 | 23.6 |
| Rubber | | | |
| Xylene | 25.7 | 25.7 | 25.7 |
| 42 degree Chlorinated | 14.2 | 14.2 | 14.2 |
| Paraffin | | | |
| R-902 Titanium Dioxide | 20 | 20 | 20 |
| Lanninox F Mica Iron | 8 | 8 | 8 |
| Oxide | | | |
| RM1920 Hydrogenated | 0.5 | 0.5 | 0.5 |
| Castor Oil | | | |
| Anti-Corrosion Additive | 6 | 6 | 6 |
| | (Exam- | (Halox 430 | (PC-B-1222 |
| | ple 8) | modified | lead |
| | | calcium | chromate) |
| | | phosphate) | |
| Rust Grade | Ri0 | Ri1 | Ri0 |
| Foaming Level | 0 | 0 | 0 |

Specific operation: the materials in the formula uniformly are mixed and dispersed to prepare the additive.

The board may be painted and sprayed according to the test formula given above, placed at room temperature for 7 days, and then put in the salt spray box for 1000 hours. The results show that the treatment of the present disclosure makes the anti-corrosion effect of the chlorinated rubber paint significantly improved.

### Application Example 6: The Additive with Synergy, Self-Repairing and Anti-Corrosion Applied in Solvent-Based Alkyd Coatings

Specifically, the anti-corrosive solvent-based alkyd paint may be formulated according to the following formula.

| Raw Material | \textcircled{1} | \textcircled{2} | \textcircled{3} |
|---|---|---|---|
| KELSOL ® 3906- | 55 | 55 | 55 |
| B2G-75 | | | |
| Alkyd Resin | | | |
| BP-183 Organic | 0.3 | 0.3 | 0.3 |
| Bentonite | | | |
| BP-183 Organic | 10 | 10 | 10 |
| Bentonite | | | |
| 800 mesh Barium | 10 | 10 | 10 |
| Sulfate | | | |
| 800 mesh Talcum | 9.4 | 9.4 | 9.4 |
| Powder | | | |
| Anti-Corrosion | 5 | 5 (Halox 430 | 5 |
| Additive | (Exam- | modified | (PC-B-1222 |
| | ple 9) | calcium | lead |
| | | phosphate) | chromate) |
| Xylene | 4 | 4 | 4 |
| No. 200 Solvent | 4 | 4 | 4 |
| Gasoline | | | |
| Cobalt Manganese | 2.2 | 2.2 | 2.2 |
| Zirconium Mixed | | | |
| Drier | | | |
| Methyl Ethyl | 0.1 | 0.1 | 0.1 |
| Ketoxinne | | | |
| Anti-skinning Agent | | | |
| Rust Level | Ri0 | Ri2 | Ri0 |
| Foaming Level | 0 | 2 | 0 |

Specific operation: the materials in the formula are mixed and dispersed uniformly to prepare the additive.

The board may be painted and sprayed according to the test formula given above, placed at room temperature for 7 days, and then put in the salt spray box for 800 h. The results show that the treatment of the present disclosure makes the anti-corrosion effect of the alkyd paint significantly improved.

What is claimed is:

1. An additive with synergy, self-repairing and anti-corrosion, comprising hydrotalcite containing exchangeable anions and zeolite containing exchangeable cations
wherein mass parts of the hydrotalcite is 10 to 80, and mass parts of the zeolite is 20 to 90,
wherein the hydrotalcite contains or more of the following exchangeable anions between layers: carbonate, molybdate, vanadate, pyrovanadate, metavanadate, phosphate, phosphite, pyrophosphate, metaphosphate, tripolyphosphate, metaborate, chromate, and dichromate;
wherein the zeolite contains one or more of the following exchangeable cations in its pores: trivalent aluminum ion, divalent zinc ion, divalent calcium ion, divalent barium ion, divalent manganese ion, trivalent iron ion, trivalent iron ion, valance chromium ion, divalent strontium ion and rare earth element ion; wherein the hydrotalcite is a modified hydrotalcite containing exchangeable anions prepared by an ion exchange method, wherein the zeolite is a modified zeolite containing exchangeable cations prepared by an ion exchange method.

2. (canceled)

3. (canceled)

4. (canceled)

5. The additive with synergy, self-repairing and anti-corrosion according to claim 1, wherein mass parts of the hydrotalcite is 30-60, and mass parts of the zeolite is 40-70.

6. (canceled)

7. (canceled)

8. An application of the additive with synergy, self-repairing and anti-corrosion of any one of claims 1-2 in preparation of anti-corrosive coatings.

9. The application according to claim 3, wherein an anti-corrosion mechanism is to absorb and exchange corrosive substances in the environment to form water-insoluble deposits, and the deposits can automatically fill and repair the gaps in the coating to prevent further penetration of corrosive substances.

10. A coating containing an additive with synergy, self-repairing and anti-corrosion according to any one of claims 1-2.
